(19) United States
(12) Patent Application Publication
(10) Pub. No.: US 2026/0139194 A1
(43) Pub. Date: May 21, 2026

(54) SUSTAINABLE AVIATION FUEL AND METHOD FOR ITS PRODUCTION

(71) Applicant: Chevron U.S.A. Inc., San Ramon, CA (US)

(72) Inventors: Krege Matthew Christison, Martinez, CA (US); Michelle Kimberly Young, Manvel, TX (US)

(21) Appl. No.: 19/395,319

(22) Filed: Nov. 20, 2025

Related U.S. Application Data
(60) Provisional application No. 63/723,366, filed on Nov. 21, 2024.

(51) Int. Cl. C10L 1/04; C11B 3/02

(52) U.S. Cl. CPC C10L 1/04; C11B 3/02; C10L 2200/0484; C10L 2270/04

(57) ABSTRACT

An aviation fuel composition including an aromatic-based product generated by fluid catalytic cracking of a lipid feedstock in the presence of a fluid catalytic cracking, wherein the aromatic-based product comprises at least 50 vol. % aromatics, and a paraffinic-based product comprising normal paraffins and iso-paraffins in an amount of at least 85 vol. %. The aviation fuel composition meets the ASTM D1655-24b specification with the added requirements in Annex A1 and/or the ASTM D7566-24d, Annexes A1-A8 specification requirements.

### PRIORITY CLAIM

The present application claims priority to U.S. Provisional Patent Application Ser. No. 63/723,366, entitled “Method for Producing 100% Drop in Sustainable Aviation Fuel,” filed Nov. 21, 2024, the content of which is incorporated by reference herein in its entirety.

### BACKGROUND

Aviation fuels or jet fuels are traditionally manufactured from crude mineral oil, which is typically separated by means of distillation into a straight run kerosene fraction boiling in the aviation fuel range, and if required, followed by optional conversion processes such as cracking. Mineral oil derived kerosene meeting aviation fuel requirements may also be produced, for example, by hydroprocessing or by caustic washing of straight run kerosene. Currently aviation fuels are produced also from renewable feedstock, i.e., a feedstock of biological origin.

In order to meet the aggressive carbon reduction targets that have been set, it will be necessary to move beyond the current 50% blend limit for sustainable aviation fuel (SAF) to 100% drop-in SAF. There is on-going discussion in the industry to attempt to develop a specification for 100% drop-in SAF so that the airline original equipment manufacturers (OEMs) have a framework to develop a future aircraft. The discussion for development of this specification is based on the use of two of the approved pathways in the ASTM D7566 Standard Specification for Aviation Turbine Fuel Containing Synthesized Hydrocarbons, namely Annex A4: the Synthesized Kerosine with Aromatics Derived by Alkylation of Light Aromatics from Non-Petroleum Sources, and Annex A6: Synthesized Kerosine from Hydrothermal Conversion of Fatty Acid Esters and Fatty Acids, or the combination of two or more synthetic blending components from Annex A1-A8 to make a fully formulated fuel.

### SUMMARY

In accordance with an aspect of the present disclosure, an aviation fuel composition comprises a blend comprising:
an aromatic-based product generated by catalytic cracking of a lipid feedstock in the presence of a cracking catalyst and under fluidized catalytic cracking conditions, wherein the aromatic-based product comprises at least 50 vol. % aromatics, and
a paraffinic-based product comprising normal paraffins and iso-paraffins in an amount of at least 85 vol. %, and
wherein the aviation fuel composition meets the ASTM D1655-24b specification with the added requirements in Annex A1 and/or the ASTM D7566-24d, Annexes A1-A8 specification requirements.

In accordance with another aspect of the present disclosure, a method comprises:
subjecting a lipid feedstock to catalytic cracking in the presence of a cracking catalyst and under fluidized catalytic cracking conditions, thereby providing an aromatic-based product comprising at least 50 vol. % aromatics,
subjecting a renewable feedstock to a hydrotreating process, thereby providing a paraffinic-based product comprising normal paraffins and iso-paraffins in an amount of at least 85 vol. %, and
blending the aromatic-based product with the paraffinic-based product, thereby providing an aviation fuel composition meeting the ASTM D1655-24b specification with the added requirements in Annex A1 and/or the ASTM D7566-24d, Annexes A1-A8 specification requirements.

### BRIEF DESCRIPTION OF THE DRAWING

In combination with the accompanying drawing and with reference to the following detailed description, the features, advantages, and other aspects of the implementations of the present disclosure will become more apparent, and several implementations of the present disclosure are illustrated herein by way of example but not limitation. In the accompanying drawing:

FIG. 1 depicts a schematic of an illustrative fluid catalytic cracking (FCC) system, according to an aspect of the present disclosure.

### DETAILED DESCRIPTION

Various illustrative embodiments described herein are directed to methods and aviation fuel compositions, which meet the ASTM D1655-24b specification with the added requirements in Annex A1 and/or the ASTM D7566-24d, Annexes A1-A8 specification requirements, for use as a 100% drop-in sustainable aviation fuel.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

As used in this disclosure, the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements with the exception of only minor traces of impurities.

The terms “a,” “an,” and “the” are intended to include plural alternatives, e.g., at least one. The terms “including,” “with,” and “having,” as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about,” from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means±20% of the stated value, ±15% of the stated value, ±10% of the stated value, ±5% of the stated value, ±3% of the stated value, or ±1% of the stated value.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

A “fresh catalyst” as used herein denotes a catalyst which has not previously been used in a catalytic process.

A “spent catalyst” as used herein denotes a catalyst that has less activity at the same reaction conditions (e.g., temperature, pressure, inlet flows) than the catalyst had when it was originally exposed to the process. This can be due to a number of reasons, several non-limiting examples of causes of catalyst deactivation are coking or carbonaceous material sorption or accumulation, steam or hydrothermal deactivation, metals (and ash) sorption or accumulation, attrition, morphological changes including changes in pore sizes, cation or anion substitution, and/or chemical or compositional changes.

A “regenerated catalyst” as used herein denotes a catalyst that had become spent, as defined above, and was then subjected to a process that increased its activity to a level greater than it had as a spent catalyst. This may involve, for example, reversing transformations or removing contaminants outlined above as possible causes of reduced activity. The regenerated catalyst typically has an activity that is equal to or less than the fresh catalyst activity.

The term “primarily” shall be understood to mean an amount greater than 50%, e.g., 50.01 to 100%, or any range between, e.g., 51 to 95%, 75% to 90%, at least 60%, at least 70%, at least 80%, etc.

The term “hydrotreating” shall refer to operations whose primary purpose is to remove impurities such as sulfur, nitrogen, oxygen, halides, and trace metals from the feedstock and saturate olefins and/or stabilize hydrocarbon free radicals by reacting them with hydrogen rather than allowing them to react with themselves. The primary purpose is not to change the boiling range of the feedstock. Hydrotreating is most often carried out using a fixed bed reactor, although other hydroconversion reactors can also be used for hydrotreating, an example of which is an ebullated bed hydrotreater.

The term “hydroprocessing” generally encompasses all processes in which a hydrocarbon feedstock is reacted with hydrogen in the presence of a catalyst and under hydroprocessing conditions, typically, at elevated temperature and elevated pressure. Hydroprocessing includes, for example, processes such as hydrogenation, hydrodeoxygenation, hydrodesulfurization, hydrodenitrogenation, hydrodemetallization, hydrodearomatization, hydroisomerization, hydrodewaxing, hydrocracking and mild hydrocracking.

The term “hydrocracking,” as used herein refers to a process in which hydrocarbons crack in the presence of a hydrogen stream and a hydrocracking catalyst to lower molecular weight hydrocarbons. Hydrocracking also includes slurry hydrocracking in which a feed is mixed with a slurry catalyst and hydrogen to make a slurry and cracked to lower boiling products.

The term “zone” can refer to an area including one or more equipment items and/or one or more sub-zones. Equipment items can include one or more reactors or reactor vessels, separation vessels, distillation towers, heaters, exchangers, pipes, pumps, compressors, and controllers. Additionally, an equipment item, such as a reactor, dryer, or vessel, can further include one or more zones or sub-zones.

The term “effluent” refers to a stream that is passed out of a reactor, a reaction zone, or a separator following a particular reaction or separation. Generally, an effluent has a different composition than the stream that entered the reactor, reaction zone, or separator. It should be understood that when an effluent is passed to another component or system, only a portion of that effluent may be passed. For example, a slipstream may carry some of the effluent away, meaning that only a portion of the effluent may enter the downstream component or system.

The term “lipid” is known in the art and refers to fatty acids and their derivatives. Representative examples of lipids include fatty acids (both saturated and unsaturated); glycerides or glycerolipids, also referred to as acylglycerols (such as monoglycerides (monoacylgycerols), diglycerides (diacylglycerols), triglycerides (triacylglycerols, TAGs, or neutral fats); phosphoglycerides (glycerophospholipids); nonglycerides (sphingolipids, sterol lipids, including cholesterol and steroid hormones, prenol lipids including terpenoids, fatty alcohols, waxes, and polyketides); and complex lipid derivatives (sugar-linked lipids or glycolipids, and protein-linked lipids).

The term “fatty acid” refers to a monocarboxylic acid having an aliphatic chain containing about 3 to about 39 carbon atoms, and more particularly about 7 to about 23 carbon atoms. The aliphatic chain may be linear or branched and may be saturated or unsaturated (e.g., contain one or more carbon-carbon double bonds).

The term “renewable feedstock” as used herein refers to a material originating from a renewable resource (e.g., plants) and non-geologically derived. The term “renewable” is also synonymous with the term “sustainable”, “sustainably derived”, or “from sustainable sources”. The term “geologically derived” means originating from, for example, crude oil, natural gas, or coal. “Geologically derived” materials cannot be easily replenished or regrown (e.g., in contrast to plant- or algae-produced oils).

The term “paraffins” as used herein means non-cyclic, branched or unbranched alkanes. An unbranched paraffin is a normal paraffin (i.e., n-paraffin); a branched paraffin is an iso-paraffin (also referred to as an “isoparaffin”).

The term “ppm” as used herein means parts-per-million and is a weight relative parameter. A part-per-million is a microgram per gram, such that a component that is present at 10 ppm is present at 10 micrograms of the specific component per 1 gram of the aggregate mixture.

The terms “wt. %,” “vol. %” or “mol. %” refers to a weight, volume, or molar percentage of a component, respectively, based on the total weight, the total volume, or the total moles of material that includes the component. In a non-limiting example, 10 moles of component in 100 moles of the material are 10 mol. % of component.

As mentioned above, in order to meet the aggressive carbon reduction targets that have been set, it will be necessary to move beyond the current 50% blend limit for sustainable aviation fuel (SAF) to 100% drop-in SAF. The driving force for the use of the annexes in the development of a 100% drop-in SAF specification is that the resulting components from some of these processes contain aromatic hydrocarbons from non-petroleum sources and the resulting fuels are considered “fully formulated.” Aromatic hydrocarbons are desirable because they prevent the loss of seal swell in aircraft that have been using traditional jet fuel. The problem with these processes from a petroleum refinery production perspective is that they use equipment that is not found within a traditional petroleum refinery and require third party purchase or expensive upgrades. A process for producing SAF from a renewable feedstock within a refinery without the considerations noted above is therefore desired.

The illustrative embodiments described herein overcome these and other drawbacks by providing an aviation fuel composition that meets the ASTM D1655-24b specification with the added requirements in Annex A1 and/or the ASTM D7566-24d, Annexes A1-A8 specification requirements. By providing such an aviation fuel composition, a fully-formulated 100% drop-in SAF can be obtained that meets established product quality requirements. The aviation fuel composition disclosed herein can advantageously be obtained in a petroleum refinery. By operating within a petroleum refinery, the process disclosed herein allows for capital efficiency, lowering the carbon intensity of the petroleum refinery, and the time to market of the aviation fuel composition since there is no need to build greenfield infrastructure.

Accordingly, an aviation fuel composition according to the present disclosure comprises a blend comprising:
an aromatic-based product generated by catalytic cracking of a lipid feedstock in the presence of a cracking catalyst and under fluidized catalytic cracking conditions, wherein the aromatic-based product comprises at least 50 vol. % aromatics, and
a paraffinic-based product comprising normal paraffins and iso-paraffins in an amount of at least 85 vol. %,
wherein the aviation fuel composition meets the ASTM D1655-24b specification with the added requirements in Annex A1 and/or the ASTM D7566-24d, Annexes A1-A8 specification requirements.

### Aromatic-Based Product

The aviation fuel composition according to the present disclosure includes an aromatic-based product generated by catalytic cracking of a lipid feedstock in the presence of a cracking catalyst under fluidized catalytic cracking conditions, wherein the aromatic-based product comprises at least 50 vol. % aromatics.

### 1. Lipid Feedstock

The lipid feedstock may originate from a renewable or biological source or sources, and it is meant to include herein feedstocks other than those obtained from mineral oil, shale oil or coal.

In an illustrative embodiment, suitable lipid feedstocks for use herein can include, for example, from 0 to about 90 wt. % of free fatty acids, about 5 to 100 wt. % fatty acid glycerol esters (e.g., mono-, di-, triglycerides) and 0 to about 20 wt. % of one or more compounds selected from the group consisting of fatty acid esters of the non-glycerol type, fatty amides, and fatty alcohols. In an illustrative embodiment, as may be combined with the preceding embodiment, the lipid feedstock comprises more than about 50 wt. % of free fatty acids and fatty acid glycerol esters such as about 70 wt. % or more, for example, about 80 wt. % or more and up to 100 wt. %.

In an illustrative embodiment, a lipid feedstock may include lipids (e.g., fats or oils) that originate, for example, from any type of plant, animal, microorganisms such as algae (e.g., algae oil, algae biomass, algae cultivation), fish and microbiological process. In an embodiment, the lipid feedstocks used include triglycerides.

Many different lipid feedstocks derived from plants can be used. In non-limiting illustrative embodiments, plant-based lipid feedstocks can include, for example, rapeseed oil, soybean oil (including degummed soybean oil), canola oil, cottonseed oil, grape seed oil, mustard seed oil, corn oil, linseed oil, safflower oil, sunflower oil, poppy-seed oil, pecan oil, walnut oil, oat oil, peanut oil, rice bran oil, camellia oil, castor oil, and olive oil, palm oil, coconut oil, rice oil, algae oil, seaweed oil, Chinese Tallow tree oil. Other plant-based lipid feedstocks can be obtained from, for example, argan, avocado, babassu palm, balanites, borneo tallow nut, brazil nut, calendula, camelina, caryocar, cashew nut, chinese vegetable tallow, cocoa, coffee, cohune palm, coriander, cucurbitaceae, euphorbia, hemp, illipe, jatropha, jojoba, kenaf, kusum, macadamia nuts, mango seed, noog abyssinia, nutmeg, opium poppy, perilla, pili nut, pumpkin seed, rice bran, sacha inche, seje, sesame, shea nut, teased, allanblackia, almond, chaulmoogra, cuphea, jatropa curgas, karanja seed, neem, papaya, tonka bean, tung, and ucuuba, cajuput, clausena anisata, davana, galbanum natural oleoresin, german chamomile, hexastylis, high-geraniol monarda, juniapa-hinojo sabalero, lupine, Melissa officinalis, milfoil, ninde, patchouli, tarragon, and wormwood.

Many different lipid feedstocks derived from animals can also be used. In non-limiting illustrative embodiments, animal-based lipid feedstocks can include, for example, choice white grease, lard (pork fat), tallow (beef fat), fish oil, and poultry fat.

Many different lipid feedstocks derived from microorganisms (Eukaryotes, Eubacteria and Archaea) can also be used. In non-limiting illustrative embodiments, microbe-based lipid feed stocks can include, for example, the L-glycerol lipids of Archaea and algae and diatom oils. In some embodiments, lipid feed stocks derived from microorganisms can include bacteria, protozoa, algae, and fungi.

In some embodiments, lipid feedstocks derived from both plant and animal sources can be used such as, for example, yellow grease, white grease, and brown grease. In non-limiting illustrative embodiments, yellow, white or brown grease can include frying oils from deep fryers and can thus include fats of both plant and animal origin. Lipid feedstocks can specifically include used cooking oil. Brown grease (also known as trap grease) can include fats extracted from sewage systems and can thus include fats of both plant and animal origin. In some embodiments, lipid feedstocks used in embodiments can include non-biological lipid feedstocks. Lipid feedstocks of the invention can also include black oil.

In non-limiting illustrative embodiments, the lipid feedstocks include feedstocks originating from low value renewable waste materials, side streams, by-products, refining waste and residues, sewage sludge, and any combinations thereof.

In non-limiting illustrative embodiments, the lipid feedstocks may be selected from the group consisting of acidulated soap-stocks, fatty acid distillates from physical refining of plant oils or animal fats, distillers corn oil (DCO) from ethanol production, waste cooking oils, lard, brown grease, yellow grease, trap grease, waste fats, low-grade oils, supercritical water liquefaction oils (SCWL oils), plant oils, animal fats and any combination thereof.

In an illustrative embodiment, the lipid feedstocks can be derived from a biological raw material component such as a vegetable oil, animal fat, and algae oil. The common feature of these sources is that they are composed of glycerides and free fatty acids (FFAs). Both of these classes of compounds contain aliphatic carbon chains having from about 8 to about 24 carbon atoms. The aliphatic carbon chains in the glycerides or FFAs can be saturated or mono-, di- or poly-unsaturated aliphatic carbon atoms.

Accordingly, in an illustrative embodiment, the lipid feedstocks that can be used herein include any of those which comprise glycerides and FFAs. In one embodiment, the glycerides will contain a majority of triglycerides; however, monoglycerides and diglycerides may be present and processed as well. In an illustrative embodiment, the lipid feedstocks can contain at least about 10 wt. % triglycerides. In an illustrative embodiment, the lipid feedstocks can contain at least about 25 wt. % triglycerides. In an illustrative embodiment, the lipid feedstocks can contain at least about 50 wt. % triglycerides. In an illustrative embodiment, the lipid feedstocks can contain at least about 75 wt. % triglycerides. In an illustrative embodiment, the lipid feedstocks can contain at least about 90 wt. % triglycerides. In an illustrative embodiment, the renewable feedstock can contain 100 wt. % triglycerides.

Suitable vegetable oils include, for example, castor oil, canola oil, coconut oil, corn oil, cottonseed oil, jatropha oil, linseed oil, mustard oil, olive oil, palm oil, palm kernel oil, peanut oil, rapeseed oil, safflower oil, sesame oil, soybean oil, and sunflower oil. Suitable vegetable oils can also include processed vegetable oil materials such as the fatty acids and fatty acid (C₁ to C₅) alkyl esters derived from vegetable oils.

Representative examples of animal fats include beef fat (tallow), hog fat (lard), poultry fat, and fish oil. Useful animal fats can also include processed animal fat materials such as the fatty acids and fatty acid (C₁ to C₅) alkyl esters derived from animal fats.

In non-limiting illustrative embodiments, the lipid feedstocks can include low value lipid feedstocks, such as various types of animal fats and waste oils, which generally have a relatively high concentration of free fatty acids. One method of assessing the concentration of free fatty acids is to determine the total acid number (TAN) of the feedstock. The total acid number is the mass of potassium hydroxide (KOH) in milligrams that is required to neutralize one gram of the chemical substance being assessed.

In an illustrative embodiment, as may be combined with one or more of the preceding paragraphs, the lipid feedstocks may have a total acid number of at least about 5 mg KOH/g (e.g., about 5 to about 150 mg KOH/g, about 10 to about 150 mg KOH/g, from about 10 to about 100 mg KOH/g, from about 10 to about 50 mg KOH/g, from about 10 to about 25 mg KOH/g, or from about 10 to about 20 mg KOH/g). The total acid number can be determined using ASTM D664.

In some aspects, the lipid feedstocks predominantly comprise a lipid feedstock with no significant quantity of a hydrocarbon source or type other than the lipid feedstock. Thus, in one aspect, the lipid feedstocks introduced into a riser reactor zone of an FCC unit, as discussed below, includes a material absent a hydrocarbon source other than the lipid feedstock. The lipid feedstock introduced into the riser reactor zone can comprise less than about 10 vol. % (e.g., less than about 5 vol. %, or less than about 1 vol. %, or 0 vol. %) of a hydrocarbon source other than the lipid feedstock. By employing such a lipid feedstock, the resulting aromatic-based product obtained from the methods of the illustrative embodiments will contain little to no fossil carbon.

The lipid feedstocks can be present in the feed in a major amount. In an illustrative embodiment, as may be combined with one or more of the preceding paragraphs, the lipid feedstocks can be present in the feed in an amount greater than or equal to 50 wt. %, based on the total weight of the feed. In an illustrative embodiment, the lipid feedstocks can be present in the feed in an amount of 100 wt. %.

### 2. Cracking Catalyst

The cracking catalyst for the FCC unit is circulated through the FCC unit in a continuous manner between catalytic cracking reaction and regeneration while maintaining the cracking catalyst in the reactor. In conventional processes, a catalyst injection system maintains a continuous or semi-continuous addition of fresh catalyst to the inventory circulating between the regenerator and the reactor. In the present process, discarded or spent catalyst from a high activity FCC process is employed in the place of fresh catalyst. Spent catalyst is usually considered industrial waste and some refineries pay to dispose of this material. Advantageously, such waste spent catalyst can be re-used herein for upgrading lipid feedstocks.

The spent catalyst may be added directly to a regeneration zone of the FCC unit or at any other suitable point.

The cracking catalyst that can be used herein can be any known cracking catalyst for use in an FCC unit. Suitable cracking catalysts include, for example, FCC catalysts which generally comprise a zeolite. In an illustrative embodiment, a cracking catalyst can comprise either a large-pore zeolite or a mixture of at least one large-pore zeolite catalyst and at least one medium-pore molecular sieve catalyst. Suitable large-pore zeolites include, for example, a Y zeolite with or without rare earth metal, a HY zeolite with or without a rare earth metal, an ultra-stable Y zeolite with or without a rare earth metal, a Beta zeolite with or without a rare earth metal, and combination thereof. Suitable medium-pore zeolites include, for example, ZSM-5, ZSM-11, ZSM-12, ZSM-23, ZSM-35, ZSM-48, and other similar materials.

In non-limiting illustrative embodiments, a suitable cracking catalyst for use herein is an equilibrium catalyst (ECAT catalyst) such as, for example, typical ultra-stable Y based FCC catalysts such as Y based zeolite catalysts. In non-limiting illustrative embodiments, a suitable cracking catalyst for use herein is a circulating inventory of an equilibrium catalyst composition. In other non-limiting illustrative embodiments, a suitable cracking catalyst for use herein is a ZSM-5 catalyst.

In an illustrative embodiment, the cracking catalyst can comprise, on a dry basis, about 10 to about 50 wt. % by weight of a zeolite, about 5 to about 90 wt. % by weight of an amorphous inorganic oxide and 0 to about 70 wt. % by weight of a filler, based on the total weight of the catalytic cracking catalyst. Suitable amorphous inorganic oxides include, for example, silica, alumina, titania, zirconia, and magnesium oxide. Suitable fillers include, for example, clays such as kaolin and halloysite.

In an illustrative embodiment, a blend of large-pore and medium-pore zeolites may be used. For example, the weight ratio of the large-pore zeolite to the medium-pore size zeolite in the cracking catalyst can be in a range of about 100:0 to about 0:100.

The spent catalyst may be a metal poisoned spent catalyst. The metal can be an alkali metal, an alkaline earth metal, a transition metal, or a combination thereof. The alkali metal can be sodium (Na), potassium (K), or a combination thereof. The alkaline earth metal can be magnesium (Mg), calcium (Ca), or a combination thereof. The transition metal can be vanadium (V), nickel (Ni), iron (Fe), or a combination thereof. In some aspects, the metal poisoned spent catalyst comprises one or more metals selected from Na, K, Mg, Ca, V, Ni, and Fe. In other aspects, the metal doped spent catalyst comprises one or more metals selected from Na, K, Mg, and Ca. The metal poisoned spent catalyst can have a metal concentration of at least about 500 ppm (e.g., about 500 to about 35000 ppm, about 500 to about 20000 ppm, about 750 to about 20000 ppm, or about 500 to about 3000 ppm).

In an illustrative embodiment, as may be combined with one or more of the preceding paragraphs, the cracking catalyst can include at least about 80 wt. % (e.g., at least about 85 wt. %, at least about 90 wt. %, at least about 95 wt. %, or at least about 100 wt. %) of a phosphorus-containing ZSM-5 light olefins additive. Any conventional phosphorus-containing ZSM-5 light olefin additive typically used in an FCC process for light olefin production may be employed herein.

In an illustrative embodiment, the phosphorus-containing ZSM-5 light olefin additive may include, for example (a) about 25 wt. % to about 50 wt. % (e.g., about 40 to about 50 wt. %) of ZSM-5 zeolite, (b) about 3 wt. % to about 15 wt. % (e.g., about 5 wt. % to about 10 wt. %) of phosphorus, measured as P₂O₅, (c) about 5 wt. % to about 40 wt. % (e.g., about 10 wt. % to about 20 wt. %) of a clay, and (d) about 5 wt. % to about 20 wt. % (e.g., about 10 wt. % to about 20 wt. %) of a binder.

A suitable clay includes, for example, kaolin, halloysite, bentonite, and any combination thereof. In an embodiment, the clay is kaolin.

A suitable binder includes, for example, a silica sol, an alumina sol, pseudoboehmite alumina, bayerite alumina, gamma-alumina, and any combination thereof.

Representative examples of suitable P/ZSM-5 light olefin additives include those commercially available from such sources as Grace (e.g., OlefinsMax®, OlefinsUltra®, OlefinsUltra® HZ, OlefinsUltra® MZ and OlefinsUltra® XZ) and from Johnson Matthey (e.g., INTERCAT™, PENTACAT™ HP, PROPYL MAX™, SUPER Z™, SUPER Z EXCEL, SUPER Z EXCEED, ISOCAT™, and OCTAMAX™).

In an embodiment, the cracking catalyst may further include, for example, a large-pore molecular sieve component in addition to the phosphorus-containing ZSM-5 light olefin additive. The large-pore molecule sieve component may include, for example, a *BEA framework type zeolite (e.g., Beta zeolite) and/or a FAU framework type zeolite (e.g., Y zeolite). When used, the large-pore molecular sieve component is typically present in an amount of no more than about 20 wt. % (e.g., about 0.1 wt. % to about 20 wt. %, or about 1 wt. % to about 15 wt. %), based on the total weight of the cracking catalyst. Optionally, the additional molecular sieve component may further comprise matrix, binder and/or clay.

The cracking catalyst may be in the form of shaped microparticles, such as microspheres. The term “microparticles” as used herein refers to particles having a size of from about 0.1 microns to about 100 microns. The size of a microparticle refers to the maximum length of a particle from one side to another, measured along the longest distance of the microparticle.

The cracking catalyst may be deactivated by contact with steam prior to use in a reactor to convert the feedstock. The purpose of steam treatment is to accelerate hydrothermal aging which occurs in an operational FCC regenerator to obtain an equilibrium catalyst. Steam treatment may lead to the removal of aluminum from the framework leading to a decrease in the number of sites where framework hydrolysis can occur under hydrothermal and thermal conditions. This removal of aluminum results in an increased thermal and hydrothermal stability in dealuminated zeolites.

### 3. FCC Process

It is normally preferred to carry out the catalytic cracking in an FCC unit dedicated to lipid feed cracking (i.e., with a feed comprised entirely of lipid feedstock). In such cases, the product from the cracking unit is a renewable product produced in industrially relevant amounts by the process as described herein. By “industrially relevant amounts” is meant amounts that enter the consumer market rather than laboratory scale amounts. In one example, industrially relevant amounts are produced continuously at greater than 100 liters of renewable product per day for a time period of at least one month.

In illustrative embodiments, the process may include introducing, injecting, feeding, or co-feeding the lipid feedstock into a refinery system via a mixing zone, a nozzle, a retro-fitted port, a retro-fitted nozzle, a velocity steam line, or a live-tap. In other illustrative embodiments, the processing may comprise injecting the lipid feedstock or co-injecting when using two or more lipid feedstocks, such as co-feeding, independently or separately introducing, injecting, feeding, or co-feeding the lipid feedstock into an FCC unit. For example, the lipid feedstock may be provided, introduced, injected, fed, or co-fed proximate to each other into the reactor, reaction zone, reaction riser, stripper or riser quench of an FCC unit.

Fluid catalytic cracking is a conversion process in petroleum refineries wherein high-boiling, high-molecular weight hydrocarbon feedstocks are converted to more valuable gasoline, olefinic gases, and other products.

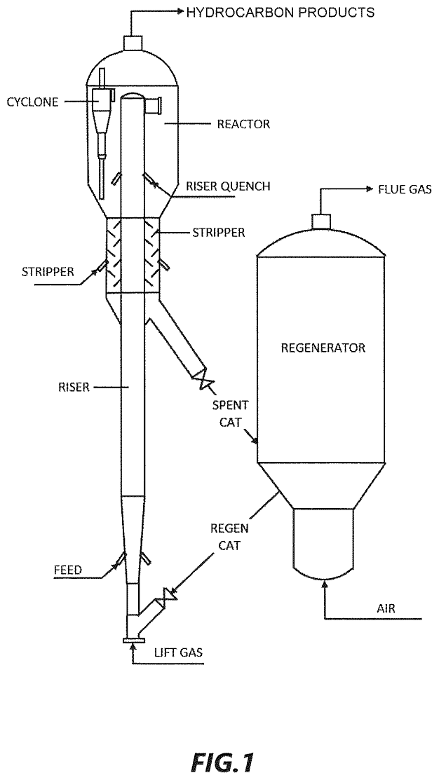

FIG. 1 depicts a schematic diagram of an illustrative an FCC unit as known in the art, according to one or more illustrative embodiments. The FCC unit includes at least a riser reactor, a cyclone (i.e., separator) and a regenerator each thereof being operatively interconnected. It is to be understood that this configuration is merely illustrative and other configurations are contemplated herein.

In illustrative embodiments, the fluidized catalytic cracking process in which the feed comprising at least one or more lipid feedstocks will be cracked to lighter hydrocarbon products takes place by contact of the feed in a cyclic catalyst recirculation cracking process with a circulating fluidizable catalytic cracking catalyst inventory as discussed above consisting of particles having a size ranging from about 20 to about 100 microns. In an illustrative embodiment, representative examples of the steps in the cyclic process include: (1) the feed is catalytically cracked in a catalytic cracking zone, normally a riser cracking zone, operating at catalytic cracking conditions by contacting the feed with a source of hot, regenerated cracking catalyst to provide an effluent comprising cracked products and spent catalyst containing coke and strippable hydrocarbons; (2) the effluent is discharged and separated, normally in one or more cyclones, into a vapor phase rich in cracked product and a solids rich phase comprising the spent catalyst; (3) the vapor phase is removed as product and fractionated in an FCC main column and its associated side columns to form liquid cracking products including an aromatic fraction as discussed below; and (4) the spent catalyst is stripped, usually with steam, to remove occluded hydrocarbons from the catalyst, after which the stripped catalyst is oxidatively regenerated to provide hot, regenerated catalyst which is then recycled to the cracking zone for cracking further quantities of feed.

Operating conditions of the FCC unit will additionally have an effect on the properties of the fuel, particularly, yields, boiling point distribution, mono-di- and polynuclear aromatic content ratio changes based on operating conditions. For example, it is desirable to provide the aromatic-based product to exclude significant amounts of dinuclear aromatics (e.g., naphthalenes) so that the total naphthalene content of the finished aviation fuel composition is less than 3.0 vol. % and the smoke point of the finished aviation fuel composition is greater than 18 millimeters. Suitable cracking conditions include, for example, a reaction temperature of about 425° C. to about 525° C. (e.g., about 450° C. to about 500° C.) with a catalyst regeneration temperature of about 600° C. to about 800° C.; a hydrocarbon partial pressure of about 100 to about 400 kPa (e.g., about 175 to about 250 kPa); a catalyst-to-oil ratio from about 2:1 to about 20:1 (e.g., about 3:1 to about 12:1, or about 5:1 to about 10:1); a catalyst contact time of about 1 to about 10 seconds (e.g., about 2 to about 5 seconds).

The term “hydrocarbon partial pressure” is used herein to indicate the overall hydrocarbon partial pressure in the riser reactor. The term “catalyst-to-oil ratio’ refers to the ratio of the catalyst circulation amount (e.g., ton/h) and the feedstock supply rate (e.g., ton/h). The term “catalyst contact time” is used herein to indicate the time from the point of contact between the feedstock and the catalyst at the catalyst inlet of the riser reactor until separation of the reaction products and the catalyst at the stripper outlet.

### 4. Products

As discussed above, after the feed comprising the one or more lipid feedstocks has been subjected to fluidized catalytic cracking conditions, the effluent from the reaction system having a variety of cracked hydrocarbon products may be separated into two or more constituent streams by conventional means. A constituent stream comprises an aromatic fraction. As one skilled in the art will readily understand, the constituent stream comprising an aromatic fraction may contain up to about 3 wt. % of phenolic compounds, e.g., from about 0.1 wt. % to about 3 wt. % of phenolic compounds. Accordingly, the constituent stream comprising an aromatic fraction can be subjected to a hydrotreating process to remove at least oxygen from the phenolic compounds, thereby providing an aromatic-based product containing at least 50 wt. % of aromatic compounds, or at least 60 wt. % of aromatic compounds. At the same time, the aromatic-based product will contain at most 80 wt. % of aromatic compounds, or at most 75 wt. % of aromatic compounds. Alternatively, the aromatic-based product can contain from 50 wt. % to about 80 wt. % of aromatic compounds, or from 60 wt. % to 75 wt. % of aromatic compounds. The aromatic-based product collected is a jet boiling range fraction containing an FCC jet component.

The hydrotreating process generally involves passing the constituent stream comprising an aromatic fraction and phenolic compounds through one or more hydrotreating reaction zones in the presence of a hydrogen stream and a hydrotreating catalyst under hydrotreating conditions to provide a liquid aromatic-based product. The hydrogen stream may be mixed with the constituent stream comprising an aromatic fraction and phenolic compounds upstream of the feed inlet to the hydrotreating reactor. Alternatively, the hydrogen stream may be added to the hydrotreating reactor independently, but concurrently, with the constituent stream comprising an aromatic fraction and phenolic compounds. In some embodiment, the hydrotreating reactor is a fixed-bed reactor. In some embodiments, the hydrotreating catalyst may be loaded to the hydrotreating reactor.

The reaction catalyzed in the hydrotreating reactor includes, for example, hydrodeoxygenation, hydrogenation, hydrodemetallization, etc. In a non-limiting illustrative embodiment, the hydrotreating process includes passing the constituent stream comprising an aromatic fraction and phenolic compounds into a hydrodeoxygenation zone in the hydrotreating reactor in the presence of the hydrogen stream and the hydrotreating catalyst (also referred to as a hydrodeoxygenated catalyst) to remove most, if not all the remaining oxygen present in the constituent stream comprising an aromatic fraction and phenolic compounds to provide the aromatic-based product.

In some embodiments, the hydrodeoxygenation reaction is operated at conditions sufficient to cause a hydrodeoxygenation reaction to provide a hydrodeoxygenated effluent having a reduced oxygen content relative to the oxygen content in the constituent stream comprising an aromatic fraction and phenolic compounds. The hydrodeoxygenation reaction may be conducted under hydrodeoxygenation reaction conditions including a pressure of from about 500 psig to about 3000 psig, a reactor temperature of from about 230° C. to 400° C., a weight hourly space velocity (WHSV) of from about 0.1 h⁻¹ to about 10 h⁻¹, and a hydrogen flow of from about 350 to about 900 NL H₂/L feed. The ratio of hydrogen gas to the constituent stream supplied to the hydrodeoxygenation zone can be in a range of from about 100 to about 1500 normal L (at standard conditions of 0° C. and 1 atm (0.1 MPa)) per kg of the constituent stream.

The hydrodeoxygenated effluent is thereafter sent to a hydrogenation zone in a hydrotreating reactor provided with a hydrogen stream and a hydrotreating catalyst (also referred to as a hydrogenation catalyst) to saturate any olefins present in the hydrodeoxygenated effluent. The catalyst used as hydrotreating catalyst for the hydrogenation process can be the same or different as the catalyst for the hydrodeoxygenation process. The hydrogenation zone is operated at conditions sufficient to cause a hydrogenation reaction of the hydrodeoxygenated effluent thereby providing the aromatic-based product.

The hydrogenation process can be operated under hydrogenation conditions including, for example, a pressure in a range of from about 100 psig to about 3000 psig, and a reactor temperature in a range from about 121° C. to about 300° C., a weight hourly space velocity (WHSV) of from about 0.1 h⁻¹ to about 10 h⁻¹, and a hydrogen flow of from about 350 to about 900 NL H₂/L feed. The ratio of hydrogen gas to the hydrodeoxygenated effluent supplied to the hydrogenation zone can be in a range of from about 100 to about 1500 normal L (at standard conditions of 0° C. and 1 atm (0.1 MPa)) per kg of the hydrodeoxygenated effluent.

### Paraffinic-Based Product

The aviation fuel composition according to the present disclosure further includes a paraffinic-based product comprising normal paraffins and iso-paraffins in an amount of greater than 85 vol. %. The paraffinic-based product is generated by hydrotreating a renewable feedstock in the presence of a hydrotreating catalyst and under hydrotreating conditions. The paraffinic-based product can be prepared according to ASTM D7566, Annex A2. Synthesized Paraffinic Kerosine from Hydroprocessed Esters and Fatty Acids.

### 1. Renewable Feedstock

The renewable feedstock may originate from any renewable or biological source or sources, and is meant to include herein feedstocks other than those obtained from, for example, mineral oil, shale oil or coal.

In an illustrative embodiment, the renewable feedstock may originate from any renewable source such as, for example, from any type of plant, animal, microorganism such as algae (e.g., algae oil, algae biomass, and algae cultivation), fish and microbiological process.

Many different renewable sources derived from plants can be used. In non-limiting illustrative embodiments, plant-based renewable sources include, for example, rapeseed oil, soybean oil (including degummed soybean oil), canola oil, cottonseed oil, grape seed oil, mustard seed oil, corn oil, linseed oil, safflower oil, sunflower oil, poppy-seed oil, pecan oil, walnut oil, oat oil, peanut oil, rice bran oil, camellia oil, castor oil, and olive oil, palm oil, coconut oil, rice oil, algae oil, seaweed oil, Chinese Tallow tree oil. Other plant-based renewable sources can be obtained from, for example, argan, avocado, babassu palm, balanites, borneo tallow nut, brazil nut, calendula, camelina, caryocar, cashew nut, Chinese vegetable tallow, cocoa, coffee, cohune palm, coriander, cucurbitaceae, euphorbia, hemp, illipe, jatropha, jojoba, kenaf, kusum, macadamia nuts, mango seed, noog abyssinia, nutmeg, opium poppy, perilla, pili nut, pumpkin seed, rice bran, sacha inche, seje, sesame, shea nut, teased, allanblackia, almond, chaulmoogra, cuphea, jatropa curgas, karanja seed, neem, papaya, tonka bean, tung, and ucuuba, cajuput, clausena anisata, davana, galbanum natural oleoresin, german chamomile, hexastylis, high-geraniol monarda, juniapa-hinojo sabalero, lupine, Melissa officinalis, milfoil, ninde, patchouli, tarragon, and wormwood.

Many different renewable sources derived from animals can also be used. In non-limiting illustrative embodiments, animal-based renewable sources can include, for example, choice white grease, lard (pork fat), tallow (beef fat), fish oil, and poultry fat.

Many different renewable sources derived from microorganisms (e.g., Eukaryotes, Eubacteria and Archaea) can also be used. In non-limiting illustrative embodiments, microbe-based renewable sources include, for example, the L-glycerol lipids of Archaea and algae and diatom oils. In some embodiments, renewable sources derived from microorganisms can include bacteria, protozoa, algae, and fungi.

In some embodiments, renewable sources derived from both plant and animal sources can be used such as, for example, yellow grease, white grease, and brown grease. In non-limiting illustrative embodiments, yellow, white or brown grease can include frying oils from deep fryers and can thus include fats of both plant and animal origin. Renewable sources can specifically include used cooking oil.

In an illustrative embodiment, renewable feedstock can be derived from a biological raw material component such as a vegetable oil, animal fat, and algae oil. The common feature of these sources is that they are composed of glycerides and free fatty acids (FFAs). Both of these classes of compounds contain aliphatic carbon chains having from about 8 to about 24 carbon atoms. The aliphatic carbon chains in the glycerides or FFAs can be saturated or mono-, di- or poly-unsaturated aliphatic carbon atoms.

Accordingly, in an illustrative embodiment, renewable feedstocks that can be used herein include any of those which comprise glycerides and FFAs. In one embodiment, the glycerides will contain a majority of triglycerides; however, monoglycerides and diglycerides may be present and processed as well. In an illustrative embodiment, the renewable feedstock can contain at least about 10 wt. % triglycerides. In an illustrative embodiment, the renewable feedstock can contain at least about 25 wt. % triglycerides. In an illustrative embodiment, the renewable feedstock can contain at least about 50 wt. % triglycerides. In an illustrative embodiment, the renewable feedstock can contain at least about 75 wt. % triglycerides. In an illustrative embodiment, the renewable feedstock can contain at least about 90 wt. % triglycerides. In an illustrative embodiment, the renewable feedstock can contain 100 wt. % triglycerides.

Suitable vegetable oils include, for example, castor oil, canola oil, coconut oil, corn oil, cottonseed oil, jatropha oil, linseed oil, mustard oil, olive oil, palm oil, palm kernel oil, peanut oil, rapeseed oil, safflower oil, sesame oil, soybean oil, and sunflower oil. Suitable vegetable oils can also include processed vegetable oil materials such as the fatty acids and fatty acid (C₁ to C₅) alkyl esters derived from vegetable oils.

Representative examples of animal fats include beef fat (tallow), hog fat (lard), poultry fat, and fish oil. Useful animal fats can also include processed animal fat materials such as the fatty acids and fatty acid (C₁ to C₅) alkyl esters derived from animal fats.

The renewable feedstock can also contain impurities. These impurities can include gums (e.g., phospholipids), suspended solids, and metals (e.g., Na, K, Mg, Ca, Mn, Fe, Cu, Zn).

In an illustrative embodiment, the renewable feedstock can be subjected to at least one purification treatment prior to being hydrotreated. In the purification treatment, the feedstock is fed to a purification unit, where the purification treatment is carried out. In the purification unit, at least one purification step is carried out. The purification step can be carried out by, for example, one or more of filtration, degumming, bleaching, solvent extraction, hydrolysis, ion-exchange resin treatment, mild acid wash, evaporative treatment, and any combination thereof. In addition, the purification steps may be the same or different. The purification unit comprises necessary equipment for carrying out the purification step or steps as known in the art. The purification unit may comprise one or more pieces of the same of different purification equipment, and, when more than one pieces of equipment are used, they are suitably arranged in series.

In some aspects, the renewable feedstock predominantly comprises a renewable feedstock with no significant quantity of a hydrocarbon source or type other than the renewable feedstock. Thus, in one aspect, the renewable feedstock introduced into a hydroprocessing reactor zone of a hydroprocessing unit, as discussed below, includes a material absent a hydrocarbon source other than the renewable feedstock. The feedstock introduced into the hydroprocessing reactor zone can comprise less than about 10 vol. % (e.g., less than about 5 vol. %, or less than about 1 vol. %, or 0 vol. %) of a hydrocarbon source other than the renewable feedstock. By employing such a renewable feedstock, the resulting paraffinic-based product obtained from the methods of the illustrative embodiments will contain little to no fossil carbon.

The renewable feedstock can be present in the feed in a major amount. In an illustrative embodiment, the renewable feedstock can be present in the feed in an amount greater than or equal to 50 wt. %, based on the total weight of the feed. In an illustrative embodiment, the renewable feedstock can be present in the feed in an amount of 100 wt. %.

### 2. Hydrotreating Process

The hydrotreating process includes a hydrotreating unit for processing the renewable feedstock, followed by an isomerization unit to cause hydrotreating and isomerization. The reaction catalyzed in the hydrotreating unit includes, for example, hydrodeoxygenation, hydrodenitrogenation, hydrodesulfurization, and/or hydrodemetallization. The hydrotreating reactor for the hydrotreating unit may be a single-stage or multi-stage and may be comprised of a single reactor or multiple reactors. The hydrotreating unit may be operated in a slurry, fluidized bed, and/or fixed bed reactor. In the case of a fixed bed reactor, each reactor may have a single catalyst bed or multiple catalyst beds. The hydrotreating unit may be operated in a co-current flow, counter-current flow, or a combination thereof.

In some embodiments, the catalyzed reaction includes at least hydrodeoxygenation, where oxygen is removed from, for example, triglycerides, diglycerides, monoglycerides, free fatty esters, and/or fatty acid esters to provide paraffinic compounds. In a non-limiting illustrative embodiment, the renewable feedstock enters a hydrodeoxygenation zone in the hydrotreating unit in the presence of a hydrodeoxygenation catalyst and hydrogen and is operated at conditions sufficient to cause a hydrodeoxygenation reaction to provide a hydrodeoxygenated liquid effluent.

The catalyzed reaction includes that at least hydrodeoxygenation of the renewable feedstock is partially or fully converted into paraffinic compounds resulting in a liquid effluent having a relatively high paraffinic content, e.g., an n-paraffin content of at least 50 vol. %, or at least 60 vol. %, or at least 85 vol. % and up to about 95 vol. %, while having no more than 15 vol. % cycloparaffins, and a low aromatic content (e.g., an aromatic content of less than about 0.5 vol. %).

The degree of hydrodeoxygenation is at least about 90%, or at least about 95%, or at least 99.9%. In this way, at least a portion of the phenolic rings in the processed liquid effluent is converted to saturated rings and at least a portion of olefinic compounds in the processed liquid effluent is converted to paraffinic compounds.

A hydrodeoxygenation catalyst for use in the hydrotreating unit may be any suitable hydrodeoxygenation catalyst known to those skilled in the art. In some embodiments, the hydrodeoxygenation catalyst includes, for example, hydrodeoxygenation catalysts such as CoMo, NiMo, NiW, CoNiMo on a support. Suitable supports include, for example, alumina, silica, alumina-silica, and zirconia.

In some embodiments, the hydrodeoxygenation reaction may be conducted under hydrodeoxygenation reaction conditions including, for example, a pressure of from about 300 psig to about 2500 psig, a temperature of from 200° C. to about 500° C. (e.g., about 250° C. to about 400° C.), a weight hourly space velocity (WHSV) of from about 0.1 h⁻¹ to about 10 h⁻¹ (e.g., about 0.2 h⁻¹ to about 5 h⁻¹), and a hydrogen flow of from about 350 to about 900 NL H₂/L feed. The ratio of hydrogen gas to the renewable feedstock supplied to the hydrodeoxygenation zone can be in a range of from about 100 to about 1500 normal L (at standard conditions of 0° C. and 1 atm (0.1 MPa)) per kg of the renewable feedstock.

In some embodiments, the hydrodeoxygenated liquid effluent can be withdrawn from the hydrotreating unit and flowed to a hydrotreating separation unit (not shown), where a gas-phase portion can be separated from a liquid-phase portion.

The hydrodeoxygenated liquid effluent is sent to a hydroisomerization zone in the isomerization unit provided with a hydroisomerization catalyst and hydrogen. The hydrotreating unit and the isomerization unit can be separate units, or the hydrotreating unit and the isomerization unit can be in the same reactor or separate reactors. In some embodiments, the hydrotreating unit and the isomerization unit are in a stacked bed relationship. In some embodiments, the hydrotreating unit and the isomerization unit have fixed-bed catalyst beds and operate in a cocurrent trickle flow.

The hydroisomerization zone is operated under hydroisomerization conditions sufficient to cause a hydroisomerization reaction of the hydrodeoxygenated liquid effluent thereby providing a paraffinic-based product. In some embodiments, at least a portion of n-paraffins is converted to iso-paraffins.

The hydroisomerization catalyst may be any suitable hydroisomerization catalyst composition known to those skilled in the art. In some embodiments, a suitable hydroisomerization catalyst includes, for example, a Group 8-10 metal of the IUPAC Periodic Table of Elements and a zeolitic material. In some embodiments, the hydroisomerization catalyst may further include a binder, such as, for example, silica, alumina, silica-alumina, and combinations thereof. In some embodiments, the Group 8-10 metal includes, for example platinum, palladium, nickel, and combinations thereof. In some embodiments, the Group 8-10 metal is a noble metal including, for example, ruthenium, rhodium, palladium, osmium, iridium, and platinum. In some embodiments, the hydroisomerization catalyst comprises the noble metal in a concentration of from 0.01 wt. % to about 5 wt. %. When the Group 8-10 metal is Ni, the hydroisomerization catalyst can also include a Group 6 metal, such as Mo or W. In some embodiments, a zeolitic material includes, for example, Beta, COK-7, EU-1, EU-2, EU-11, IZM-1, MCM-22, NU-10, SSZ-32, SSZ-91, ZSM-5, ZSM-12, ZSM-22, ZSM-23, ZSM-30, ZSM-35, ZSM-48, ZSM-50, ZSM-57, and combinations thereof.

In some embodiments, the hydroisomerization reaction may be conducted under hydroisomerization reaction condition including, for example, a pressure in a range of from about 300 psig to about 3000 psig and at a temperature in a range of from about 150° C. to about 400° C. In some embodiments, the hydroisomerization reaction may be conducted at a pressure in a range of from about 300 psig to about 2500 psig, and a temperature in a range of from about 200° C. to about 360° C. In some embodiments, the LHSV is in a range of from about 0.2 h⁻¹ to about 4 h⁻¹ based on fresh feed. The ratio of the hydrogen gas to the hydrodeoxygenated liquid effluent supplied to the hydroisomerization unit is in a range of from about 100 to about 1500 normal L (at standard conditions of 0° C. and 1 atm (0.1 MPa)) per kg of the hydrodeoxygenated liquid effluent.

In some embodiments, the hydrogen may be produced, for example, by water electrolysis. The water electrolysis process may be powered by renewable energy (such as solar photovoltaic, wind or hydroelectric power) to generate green hydrogen, nuclear energy or by non-renewable power from other sources (grey hydrogen).

### 3. Product

The resulting paraffinic-based product will have a paraffin content of at least 85 vol. %, or at least 90 vol. %, or at least 95 vol. %, while having a low aromatic content (e.g., an aromatic content of less than about 0.5 vol. %). The paraffin content can consist of at least 1 vol. % of n-paraffins, or alternatively at least 5 vol. % of n-paraffins. At the same time, the paraffin content can consist of at most 70 vol. % of n-paraffins, or alternatively at most 35 vol. % of n-paraffins. Alternatively, the paraffin content can consist of from 1 vol. % to 70 vol. % of n-paraffins, or alternatively at most 5 vol. % to 35 vol. % of n-paraffins.

The paraffin content can further consist of at least 30 vol. % of iso-paraffins, or alternatively at least 65 vol. % of iso-paraffins. At the same time, the paraffin content can consist of at most 99 vol. % of iso-paraffins, or alternatively at most 95 vol. % of iso-paraffins. Alternatively, the paraffin content can consist of from 30 vol. % to 99 vol. % of iso-paraffins, or alternatively at most 65 vol. % to 95 vol. % of iso-paraffins.

### Aviation Fuel Composition

The aviation fuel composition according to present disclosure has a content of the aromatic-based product of from about 10 vol. % to about 43 vol. % and a content of the paraffinic-based product of from about 57 vol. % to about 90 vol. %, based on the total volume of the sustainable aviation fuel. In some embodiments, the aviation fuel composition according to present embodiments has a content of the aromatic-based product of from about 14 vol. % to about 40 vol. % and a content of the paraffinic-based product of from about 60 vol. % to about 86 vol. %, based on the total volume of the sustainable aviation fuel.

The aviation fuel composition according to present disclosure can be further characterized as having an aromatic content of at least 8 vol. % to about 25 vol. %. The aviation fuel composition according to present disclosure can be further characterized as having a naphthalene content of less than 3.0 vol. %. The aviation fuel composition according to present disclosure can be further characterized as having a smoke point of greater than 18 millimeters and up to 30 mm. The aviation fuel composition according to present disclosure can be further characterized as having a freeze point of no more than −40° C. The aviation fuel composition according to present disclosure can be further characterized as having a viscosity at −40° C. of no more than 12 cSt.

The resultant blend composition forms an aviation fuel composition according to the present disclosure for subsequent drop in formulations for sustainable aviation fuels to target meeting requirements for ASTM D1655-24b specification with the added requirements in Annex A1 (see Table 7 below) and/or the ASTM D7566-24d, Annexes A1-A8.

### EXAMPLES

The following examples are provided to further illustrate the present aviation fuel composition and its benefits. The examples are meant to be illustrative and not limiting.

### Example 1

This example illustrates the preparation of an aviation fuel composition obtained by blending a paraffinic-based product of a hydroprocessed ester and fatty acid (HEFA) blend component derived from Soybean Oil and an aromatic-based product of an FCC blend component derived from Soybean Oil.

The paraffinic-based product of a HEFA blend component derived from Soybean Oil was generated by carrying out a conventional hydrodeoxygenation process using standard hydrodeoxygenation catalyst and operating conditions, and a conventional hydroisomerization using standard hydroisomerization catalyst and operating conditions, followed by fractionation.

The paraffinic-based product of a HEFA blend component derived from Soybean Oil is set forth below in Table 1.

TABLE 1
Paraffinic-based Product of a HEFA
Blend Component for Soybean Oil

| Carbon | | | | |
|---|---|---|---|---|
| Number | n-Paraffins | i-Paraffins | Naphthenes | Aromatics |
| C6 | 0.00 | 0.00 | 0.00 | 0.00 |
| C7 | 0.58 | 0.26 | 0.10 | 0.14 |
| C8 | 2.08 | 1.02 | 0.35 | 0.05 |
| C9 | 3.94 | 2.70 | 0.91 | 0.10 |
| C10 | 4.54 | 4.63 | 0.94 | 0.09 |
| C11 | 4.28 | 4.35 | 0.99 | 0.12 |
| C12 | 4.34 | 4.84 | 0.99 | 0.11 |
| C13 | 5.27 | 7.29 | 0.86 | 0.10 |
| C14 | 5.26 | 12.54 | 0.60 | 0.06 |
| C15 | 2.96 | 9.79 | 0.25 | 0.02 |
| C16 | 1.41 | 7.67 | 0.12 | 0.01 |
| C17 | 0.15 | 1.39 | 0.04 | 0.00 |
| C18 | 0.11 | 1.36 | 0.04 | 0.00 |
| C19 | 0.00 | 0.04 | 0.00 | 0.00 |
| C20 | 0.03 | 0.17 | 0.00 | 0.00 |
| Total | 34.95 | 58.05 | 6.19 | 0.78 |

The aromatic-based product of an FCC blend component derived from Soybean Oil was generated by carrying out a conventional FCC process using standard FCC catalyst and FCC operating conditions, and conventional hydrodeoxygenation process using standard hydrodeoxygenation catalyst and operating conditions, followed by fractionation.

The aromatic-based product of an FCC blend component derived from Soybean Oil is set forth below in Table 2.

TABLE 2
Aromatic-Based Product of an FCC Blend
Component Derived from Soybean Oil

| Carbon | | | | |
|---|---|---|---|---|
| Number | n-Paraffins | i-Paraffins | Naphthenes | Aromatics |
| C6 | 0.00 | 0.00 | 0.00 | 0.00 |
| C7 | 0.00 | 0.00 | 0.17 | 0.10 |
| C8 | 0.01 | 0.03 | 0.28 | 0.39 |
| C9 | 0.07 | 0.14 | 0.71 | 4.66 |
| C10 | 0.50 | 0.22 | 2.68 | 25.59 |
| C11 | 1.52 | 2.27 | 4.92 | 27.93 |
| C12 | 1.13 | 1.94 | 3.33 | 11.65 |
| C13 | 0.98 | 1.64 | 1.29 | 3.80 |
| C14 | 0.29 | 0.84 | 0.41 | 0.28 |
| C15 | 0.00 | 0.02 | 0.09 | 0.05 |
| C16 | 0.00 | 0.00 | 0.01 | 0.02 |
| C17 | 0.00 | 0.00 | 0.01 | 0.00 |
| C18 | 0.00 | 0.00 | 0.01 | 0.00 |
| C19 | 0.00 | 0.00 | 0.01 | 0.00 |
| C20 | 0.00 | 0.00 | 0.00 | 0.00 |
| Total | 4.50 | 7.10 | 13.93 | 74.48 |

Next, 75 vol. % of the paraffinic-based product of a HEFA blend component derived from Soybean Oil was blended with 25 vol. % of the aromatic-based product of an FCC blend component derived from Soybean Oil to obtain an aviation fuel composition meeting the ASTM D1655-24b specification with the added requirements in Annex A1 requirement. The aviation fuel composition is set forth below in Table 3.

TABLE 3

| Carbon | | | | |
|---|---|---|---|---|
| Number | n-Paraffins | i-Paraffins | Naphthenes | Aromatics |
| C6 | 0.00 | 0.00 | 0.00 | 0.00 |
| C7 | 0.06 | 0.02 | 0.03 | 0.00 |
| C8 | 0.49 | 0.18 | 0.16 | 0.00 |
| C9 | 2.17 | 1.14 | 0.62 | 0.58 |
| C10 | 3.93 | 3.58 | 1.22 | 2.81 |
| C11 | 3.90 | 4.44 | 2.09 | 7.72 |
| C12 | 3.56 | 5.31 | 1.87 | 4.48 |
| C13 | 4.22 | 7.34 | 1.23 | 1.90 |
| C14 | 4.41 | 11.71 | 0.58 | 0.60 |
| C15 | 0.94 | 8.60 | 0.41 | 0.06 |
| C16 | 0.27 | 5.59 | 0.18 | 0.01 |
| C17 | 0.04 | 0.91 | 0.02 | 0.00 |
| C18 | 0.01 | 0.62 | 0.00 | 0.00 |
| C19 | 0.00 | 0.00 | 0.00 | 0.00 |
| C20 | 0.00 | 0.00 | 0.00 | 0.00 |
| Total | 24.00 | 49.43 | 8.41 | 18.17 |

### Example 2

This example illustrates the preparation of an aviation fuel composition obtained by blending a paraffinic-based product of a HEFA blend component derived from Soybean Oil and an aromatic-based product of an FCC blend component derived from Canola Oil.

The paraffinic-based product of a HEFA blend component derived from Soybean Oil was generated by carrying out a conventional hydrodeoxygenation process using standard hydrodeoxygenation catalyst and operating conditions, and a conventional hydroisomerization using standard hydroisomerization catalyst and operating conditions, followed by fractionation.

The paraffinic-based product of a HEFA blend component derived from Soybean Oil is set forth below in Table 4.

TABLE 4
Paraffinic-based Product of a HEFA
Blend Component for Soybean Oil

| Carbon | | | | |
|---|---|---|---|---|
| Number | n-Paraffins | i-Paraffins | Naphthenes | Aromatics |
| C6 | 0.00 | 0.00 | 0.01 | 0.00 |
| C7 | 0.12 | 0.02 | 0.02 | 0.00 |
| C8 | 0.34 | 0.66 | 0.07 | 0.02 |
| C9 | 0.53 | 0.89 | 0.14 | 0.03 |
| C10 | 0.68 | 2.02 | 0.21 | 0.04 |
| C11 | 0.77 | 3.68 | 0.32 | 0.04 |
| C12 | 0.68 | 6.52 | 0.57 | 0.04 |
| C13 | 0.55 | 12.00 | 0.70 | 0.06 |
| C14 | 0.32 | 12.97 | 0.46 | 0.70 |
| C15 | 0.19 | 10.26 | 0.42 | 0.03 |
| C16 | 0.13 | 16.89 | 0.16 | 0.04 |
| C17 | 0.03 | 11.20 | 0.08 | 0.04 |
| C18 | 0.01 | 13.44 | 0.04 | 0.00 |
| C19 | 0.00 | 0.00 | 0.00 | 0.00 |
| C20 | 0.00 | 0.00 | 0.00 | 0.00 |
| Total | 4.35 | 90.54 | 3.20 | 1.04 |

The aromatic-based product of an FCC blend component derived from Canola Oil was generated by carrying out a conventional FCC process using standard FCC catalyst and FCC operating conditions, and conventional hydrodeoxygenation process using standard hydrodeoxygenation catalyst and operating conditions, followed by fractionation.

The aromatic-based product of an FCC blend component derived from Canola Oil is set forth below in Table 5.

TABLE 5
Aromatic-Based Product of an FCC Blend
Component Derived from Canola Oil

| Carbon | | | | |
|---|---|---|---|---|
| Number | n-Paraffins | i-Paraffins | Naphthenes | Aromatics |
| C6 | 0.05 | 0.04 | 0.06 | 0.02 |
| C7 | 0.75 | 1.42 | 0.82 | 3.19 |
| C8 | 1.45 | 3.64 | 2.55 | 7.99 |
| C9 | 0.90 | 2.59 | 4.84 | 9.85 |
| C10 | 0.53 | 1,59 | 3.92 | 9.57 |
| C11 | 0.49 | 0.96 | 2.47 | 10.31 |
| C12 | 0.36 | 0.75 | 2.36 | 8.72 |
| C13 | 0.19 | 0.43 | 2.04 | 2.93 |
| C14 | 0.13 | 0.24 | 0.98 | 3.55 |
| C15 | 0.39 | 0.25 | 0.47 | 1.34 |
| C16 | 0.11 | 0.28 | 0.31 | 0.44 |
| C17 | 0.20 | 0.27 | 0.31 | 0.26 |
| C18 | 0.02 | 0.19 | 0.34 | 0.14 |
| C19 | 0.01 | 0.05 | 0.11 | 0.04 |
| C20 | 0.00 | 0.02 | 0.04 | 0.01 |
| Total | 5.59 | 12.70 | 21.62 | 58.38 |

Next, 60 vol. % of the paraffinic-based product of a HEFA blend component derived from Canola Oil was blended with 40 vol. % of the aromatic-based product of an FCC blend component derived from Canola Oil to obtain an aviation fuel composition meeting the ASTM D1655-24b specification with the added requirements in Annex A1 requirement. The aviation fuel composition is set forth below in Table 6.

TABLE 6

| Carbon | | | | |
|---|---|---|---|---|
| Number | n-Paraffins | i-Paraffins | Naphthenes | Aromatics |
| C6 | 0.00 | 0.00 | 0.09 | 0.02 |
| C7 | 0.04 | 0.98 | 0.72 | 1.22 |
| C8 | 0.70 | 1.77 | 1.43 | 3.03 |
| C9 | 0.66 | 1.49 | 1.30 | 3.63 |
| C10 | 0.56 | 1.90 | 1.30 | 3.98 |
| C11 | 0.63 | 2.70 | 1.24 | 3.38 |
| C12 | 0.59 | 4.54 | 1.26 | 2.99 |
| C13 | 0.39 | 7.49 | 0.95 | 2.14 |
| C14 | 0.19 | 7.69 | 0.71 | 1.20 |
| C15 | 0.33 | 6.87 | 0.42 | 0.41 |
| C16 | 0.14 | 10.49 | 0.64 | 0.16 |
| C17 | 0.08 | 7.36 | 0.50 | 0.12 |
| C18 | 0.01 | 7.83 | 0.25 | 0.00 |
| C19 | 0.00 | 0.01 | 0.03 | 0.08 |
| C20 | 0.00 | 0.01 | 0.03 | 0.00 |
| Total | 4.32 | 61.15 | 10.89 | 22.35 |

The aviation fuel compositions of Examples 1 and 2 met the ASTM D1655-24b specification with the added requirements in Annex A1 requirement as shown below in Table 7.

TABLE 7

| | | | ASTM D1655 | ASTM |
|---|---|---|---|---|
| Measured Property | Example 1 | Example 2 | Limits | Test Method |
| Acid Number, mg KOH/g | <0.05 | <0.05 | 0.1 max | D3242 |
| Aromatics, vol. % | 19.01 | 22.19 | 25 max | D8267 |
| Mercaptan Sulfur, mg/kg | <1 | <1 | 30 max | D3227 |
| Total Sulfur, mg/kg | <5 | <5 | 3000 max | D4294 |
| Distillation, T10 (° C.) | 189 | 164 | 205 max | D86 |
| Distillation, T50 (° C.) | 217 | 229 | report | D86 |
| Distillation, T90 (° C.) | 248 | 268 | report | D86 |
| Distillation FBP (° C.) | 267 | 280 | 300 max | D86 |
| Distillation Residue, vol. % | 1.2 | 1.2 | 1.5 max | D86 |
| Distillation loss, vol. % | 1.4 | 0.7 | 1.5 max | D86 |
| Flash Point, ° C. | 63 | 38 | 38 min | D93 |
| Density, g/mL | 0.788 | 0.800 | 0.775-0.840 | D4052 |
| Freeze Point, ° C. | −43.5 | −66.3 | −40 max | D5972 |
| Viscosity, cSt | 5.149 | 5.6 | 8 max at −20° C. | D7945 |
| Viscosity, cSt | 10.97 | 11.8 | 12 max at −40° C. | D7945 |
| | | | (Annex A1) | |
| Net Heat of | 43.3 | 42.9 | 42.8 min | D4809 |
| Combustion, MJ/kg | | | | |
| Smoke Point, mm | 27.0 | 22.0 | 18 mm | D1322 |
| Naphthalenes, vol. % | 1.4 | 0.1 | 3.0 max | D1840 |
| Copper Corrosion | 1b | 1a | 1 max | D130 |
| JFTOT ITR (260° C.) | 4.9 | 9.4 | 85 max | D3241 |
| JFTOT dP, mmHg | 0 | 0 | 25 max | D3241 |
| Existent Gum, mg/100 mL | 1 | 1 | 7 max | D381 |
| MSEP | 99 | 99 | 85 min | D3948 |
| Total Nitrogen, mg/kg | <0.3 | <0.3 | no spec | |
| Basic Nitrogen, mg/kg | <1 | <1 | no spec | |
| Metals by ICP/MS | Below | Below | no spec | |
| | Detection | Detection | | |

According to an aspect of the present disclosure, an aviation fuel composition comprises:
an aromatic-based product generated by fluid catalytic cracking of a lipid feedstock in the presence of a fluid catalytic cracking, wherein the aromatic-based product comprises at least 50 vol. % aromatics, and
a paraffinic-based product comprising normal paraffins and iso-paraffins in an amount of at least 85 vol. %,
wherein the aviation fuel composition meets the ASTM D1655-24b specification with the added requirements in Annex A1 and/or the ASTM D7566-24d, Annexes A1-A8 specification requirements.

In non-limiting illustrative embodiments, as may be combined with one or more of the preceding paragraphs, the lipid feedstock comprises a fatty acid.

In non-limiting illustrative embodiments, as may be combined with one or more of the preceding paragraphs, the paraffinic-based product is generated from a renewable feedstock.

In non-limiting illustrative embodiments, as may be combined with one or more of the preceding paragraphs, the renewable feedstock comprises one or more of animal fats, animal oils, plant fats, plant oils, vegetable fats, vegetable oils, greases, and used cooking oil.

In non-limiting illustrative embodiments, as may be combined with one or more of the preceding paragraphs, the aviation fuel composition comprises a content of the aromatic-based product of from about 10 vol. % to about 43 vol. % and a content of the paraffinic-based product of from about 57 vol. % to about 90 vol. %, based on the total volume of the aviation fuel composition.

In non-limiting illustrative embodiments, as may be combined with one or more of the preceding paragraphs, the aviation fuel composition comprises a content of the aromatic-based product of from about 14 vol. % to about 40 vol. % and a content of the paraffinic-based product of from about 60 vol. % to about 86 vol. %, based on the total volume of the aviation fuel composition.

In non-limiting illustrative embodiments, as may be combined with one or more of the preceding paragraphs, the aviation fuel composition comprises an aromatic content of at least 8 vol. % to about 25 vol. %.

In non-limiting illustrative embodiments, as may be combined with one or more of the preceding paragraphs, the aviation fuel composition comprises a naphthalene content of less than 3.0 vol. %.

In non-limiting illustrative embodiments, as may be combined with one or more of the preceding paragraphs, the aviation fuel composition comprises an aromatic content of at least 8 vol. % to about 25 vol. %, and a naphthalene content of less than 3.0 vol. %.

In non-limiting illustrative embodiments, as may be combined with one or more of the preceding paragraphs, the aviation fuel composition comprises a freeze point of no more than −40° C.

According to another aspect of the present disclosure, a method comprises:
subjecting a lipid feedstock to catalytic cracking in the presence of a cracking catalyst and under fluidized catalytic cracking conditions, thereby providing an aromatic-based product comprising at least 50 vol. % aromatics,
subjecting a renewable feedstock to a hydrotreating process, thereby providing a paraffinic-based product comprising normal paraffins and iso-paraffins in an amount of at least 85 vol. %, and
blending the aromatic-based product with the paraffinic-based product, thereby providing an aviation fuel composition meeting the ASTM D1655-24b specification with the added requirements in Annex A1 and/or the ASTM D7566-24d, Annexes A1-A8 specification requirements.

In non-limiting illustrative embodiments, as may be combined with one or more of the preceding paragraphs, the subjecting the lipid feedstock to catalytic cracking in further comprises processing, in a hydrotreating reactor, a product obtained by the catalytic cracking of the lipid feedstock in the presence of a hydrodeoxygenation catalyst and under hydrodeoxygenation reaction conditions, thereby providing a hydrodeoxygenated effluent, and processing the hydrodeoxygenated effluent in the presence of a hydrogenation catalyst and under hydrogenation reaction conditions, thereby providing the aromatic-based product.

In non-limiting illustrative embodiments, as may be combined with one or more of the preceding paragraphs, the hydrotreating process comprises processing, in a hydrotreating reactor, the renewable feedstock in the presence of a hydrodeoxygenation catalyst and under hydrodeoxygenation reaction conditions, thereby providing a hydrodeoxygenated liquid effluent, and processing the hydrodeoxygenated liquid effluent in the presence of a hydroisomerization catalyst and under hydroisomerization conditions, thereby providing the paraffinic-based product.

In non-limiting illustrative embodiments, as may be combined with one or more of the preceding paragraphs, the aviation fuel composition comprises a content of the aromatic-based product of from about 10 vol. % to about 43 vol. % and a content of the paraffinic-based product of from about 57 vol. % to about 90 vol. %, based on the total volume of the aviation fuel composition.

In non-limiting illustrative embodiments, as may be combined with one or more of the preceding paragraphs, the aviation fuel composition comprises a content of the aromatic-based product of from about 14 vol. % to about 40 vol. % and a content of the paraffinic-based product of from about 60 vol. % to about 86 vol. %, based on the total volume of the aviation fuel composition.

In non-limiting illustrative embodiments, as may be combined with one or more of the preceding paragraphs, the aviation fuel composition comprises an aromatic content of at least 8 vol. % to about 25 vol. %.

In non-limiting illustrative embodiments, as may be combined with one or more of the preceding paragraphs, the aviation fuel composition comprises a naphthalene content of less than 3.0 vol. %.

In non-limiting illustrative embodiments, as may be combined with one or more of the preceding paragraphs, the aviation fuel composition comprises an aromatic content of at least 8 vol. % to about 25 vol. %, and a naphthalene content of less than 3.0 vol. %.

In non-limiting illustrative embodiments, as may be combined with one or more of the preceding paragraphs, the lipid feedstock comprises a fatty acid and the paraffinic-based product is generated from a renewable feedstock.

In non-limiting illustrative embodiments, as may be combined with one or more of the preceding paragraphs, the renewable feedstock comprises one or more of animal fats, animal oils, plant fats, plant oils, vegetable fats, vegetable oils, greases, and used cooking oil.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present disclosure and are disclosed herein just as if each and every such sub-combination was individually and explicitly disclosed herein.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. An aviation fuel composition, comprising:
an aromatic-based product generated by fluid catalytic cracking of a lipid feedstock in the presence of a fluid catalytic cracking, wherein the aromatic-based product comprises at least 50 vol. % aromatics; and
a paraffinic-based product comprising normal paraffins and iso-paraffins in an amount of at least 85 vol. %;
wherein the aviation fuel composition meets the ASTM D1655-24b specification with the added requirements in Annex A1 and/or the ASTM D7566-24d, Annexes A1-A8 specification requirements.

2. The aviation fuel composition according to claim 1, wherein the lipid feedstock comprises a fatty acid.

3. The aviation fuel composition according to claim 1, wherein the paraffinic-based product is generated from a renewable feedstock.

4. The aviation fuel composition according to claim 3, wherein the renewable feedstock comprises one or more of animal fats, animal oils, plant fats, plant oils, vegetable fats, vegetable oils, greases, and used cooking oil.

5. The aviation fuel composition according to claim 1, comprising a content of the aromatic-based product of from about 10 vol. % to about 43 vol. % and a content of the paraffinic-based product of from about 57 vol. % to about 90 vol. %, based on the total volume of the aviation fuel composition.

6. The aviation fuel composition according to claim 1, comprising a content of the aromatic-based product of from about 14 vol. % to about 40 vol. % and a content of the paraffinic-based product of from about 60 vol. % to about 86 vol. %, based on the total volume of the aviation fuel composition.

7. The aviation fuel composition according to claim 1, comprising an aromatic content of at least 8 vol. % to about 25 vol. %.

8. The aviation fuel composition according to claim 1, comprising a naphthalene content of less than 3.0 vol. %.

9. The aviation fuel composition according to claim 1, comprising an aromatic content of at least 8 vol. % to about 25 vol. %, and a naphthalene content of less than 3.0 vol. %.

10. The aviation fuel composition according to claim 9, further comprising a freeze point of no more than −40° C.

11. A method, comprising:
subjecting a lipid feedstock to catalytic cracking in the presence of a cracking catalyst and under fluidized catalytic cracking conditions, thereby providing an aromatic-based product comprising at least 50 vol. % aromatics;
subjecting a renewable feedstock to a hydrotreating process, thereby providing a paraffinic-based product comprising normal paraffins and iso-paraffins in an amount of at least 85 vol. %; and
blending the aromatic-based product with the paraffinic-based product, thereby providing an aviation fuel composition meeting the ASTM D1655-24b specification with the added requirements in Annex A1 and/or the ASTM D7566-24d, Annexes A1-A8 specification requirements.

12. The method according to claim 11, wherein the subjecting the lipid feedstock to catalytic cracking further comprises processing, in a hydrotreating reactor, a product obtained by the catalytic cracking of the lipid feedstock in the presence of a hydrodeoxygenation catalyst and under hydrodeoxygenation reaction conditions, thereby providing a hydrodeoxygenated effluent, and processing the hydrodeoxygenated effluent in the presence of a hydrogenation catalyst and under hydrogenation reaction conditions, thereby providing the aromatic-based product.

13. The method according to claim 11, wherein the hydrotreating process comprises processing, in a hydrotreating reactor, the renewable feedstock in the presence of a hydrodeoxygenation catalyst and under hydrodeoxygenation reaction conditions, thereby providing a hydrodeoxygenated liquid effluent, and processing the hydrodeoxygenated liquid effluent in the presence of a hydroisomerization catalyst and under hydroisomerization conditions, thereby providing the paraffinic-based product.

14. The method according to claim 11, wherein the aviation fuel composition comprises a content of the aromatic-based product of from about 10 vol. % to about 43 vol. % and a content of the paraffinic-based product of from about 57 vol. % to about 90 vol. %, based on the total volume of the aviation fuel composition.

15. The method according to claim 11, wherein the aviation fuel composition comprises a content of the aromatic-based product of from about 14 vol. % to about 40 vol. % and a content of the paraffinic-based product of from about 60 vol. % to about 86 vol. %, based on the total volume of the aviation fuel composition.

16. The method according to claim 11, wherein the aviation fuel composition comprises an aromatic content of at least 8 vol. % to about 25 vol. %.

17. The method according to claim 11, wherein the aviation fuel composition comprises a naphthalene content of less than 3.0 vol. %.

18. The method according to claim 11, wherein the aviation fuel composition comprises an aromatic content of at least 8 vol. % to about 25 vol. %, and a naphthalene content of less than 3.0 vol. %.

19. The method according to claim 11, wherein the lipid feedstock comprises a fatty acid and the paraffinic-based product is generated from a renewable feedstock.

20. The method according to claim 19, wherein the renewable feedstock comprises one or more of animal fats, animal oils, plant fats, plant oils, vegetable fats, vegetable oils, greases, and used cooking oil.
